(19) United States
(12) Patent Application Publication
(10) Pub. No.: US 2006/0031381 A1
(43) Pub. Date: Feb. 9, 2006

(54) Method and device for regulating file sharing

(75) Inventors: Balthasar Antonius Gerardus Van Luijt, Eindhoven (NL); Antonius Adrianus Cornelis Maria Kalker, Eindhoven (NL); Jaap Andre Haitsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electrices N.V.

(21) Appl. No.: 10/521,704

(22) PCT Filed: Jul. 10, 2003
(86) PCT No.: PCT/IB03/03064

§ 371 Date: Jan. 19, 2005

(30) Foreign Application Priority Data
Jul. 24, 2002 (EP) 02078013.6

(51) Int. Cl. G06F 15/16

(52) U.S. Cl. 709/217

(57) ABSTRACT

A method of regulating sharing of a multimedia object (200) by a device (100), comprising registering usage information for the multimedia object (200) upon sharing of the multimedia object (200), and after the registering, billing a user of the device (100) for a certain amount in accordance with the registered usage information for the multimedia object (200). Registration preferably takes place in a client (101) arranged for sharing of the multimedia object (200). The usage information could for instance comprise the number of times a multimedia object has been shared, or the duration of the object. If a sufficient number of objects have been shared, or if the total time exceeds a maximum, the client (101) reports the usage information to a third party (130) for billing purposes.

The invention relates to the sharing of multimedia objects, for example peer-to-peer type sharing, and in particular to the regulation of such sharing.

File sharing services such as Napster (http://www.napster.com/), KaZaa (http://www.kazaa.com/) or Gnutella (http://www.gnutella.co.uk/) are widely known on the Internet. They are used by millions of users to exchange multimedia objects such as music, typically in MP3 format. Each user can offer his own music collection to everyone else, which allows everyone to have a large selection of music available for downloading. However, the music offered on these file-sharing services is typically popular music, and is offered without the permission of the copyright holders. To ensure the copyright holders get the royalties they are entitled to, some file sharing services have started to charge a subscription fee to its users. Part of the revenue from the subscription fees can then be used to pay the copyright holders.

Recently various so-called Digital Rights Management (DRM) systems have been developed. In their most basic form, the systems simply try to prevent copying of content. Such systems are sometimes also referred to as copy protection systems. More extensive DRM systems provide elaborate rights management to facilitate various different business models. For example, a user can purchase a right to play back a multimedia object ten times, or a right to distribute a copy of the multimedia object to another user.

Most users at present are accustomed to freely sharing the multimedia objects they purchase on compact discs or DVDs, or the objects they download from other users. This suggests that the new DRM-based business models might not be well received by these users. However, if unlimited copying and distribution in digital form is permitted without any form of copyright protection, the content industry will be seriously harmed. A fair balance between the interests of the rights holders and the desires of the users needs to be struck.

It is an object of the present invention to provide a method according to the preamble, which balances the interests of the rights holders and the desires of the users.

This object is achieved according to the present invention in a method as claimed in claim 1. By permitting unlimited sharing of the multimedia object, the method does not hamper the interests of the user. All sharing is registered. The registered usage information for instance comprises the number of times the multimedia object has been shared, how long the multimedia object lasts, and so on.

The sharing of the multimedia object is registered or metered, typically in the device in which such sharing takes place. The registered usage information can then be supplied to the (copy)rights holder for the multimedia object, or to a rights clearinghouse or to another third party. The receiving party can then bill the user for his sharing of the multimedia object in accordance with his actual file sharing activity. The rights holder thus now receives a fair compensation for the usage of his content.

There is now no longer a need to protect against unauthorized copying: the more copies are made, the more copies are played back, and the more money the rights holders makes.

In an embodiment the method further comprises recording user profile information for the user, and crediting the bill with a sum upon receipt of the recorded user profile information together with the registered usage information. User profile information, for example indicating which television program the user watches or what music he is interested in, can be very valuable information, especially to advertisers. To entice users in supplying this information, their usage bill is credited with a certain amount if they are willing to share their profiling information.

It is a further object of the invention to provide a device according to the preamble, which enables balancing the interests of the rights holders and the desires of the users.

This object is achieved according to the present invention in a device as claimed in claim 3. Using the identification and accounting means, it becomes possible to register or meter the sharing of the multimedia object in the device. The registered usage information can then be transmitted to a third party for afterwards billing purposes. Such a device does not inhibit the sharing of the multimedia object. The user can share or otherwise use the content exactly as he wishes. On the other hand, the registered usage information allows a third party to send a bill so as to collect royalties for the usage of its content. This way, a fair balance between the interests of the rights holders and the desires of the users is struck.

In an embodiment the identifying means are arranged to obtain the identifier from metadata associated with the content item, preferably using a watermark detector arranged to detect a watermark in the content item and to extract the identifier from the metadata encoded using the watermark.

In another embodiment the identifying means comprise a fingerprint calculator arranged to obtain the identifier by computing a fingerprint for at least a portion of the multimedia object. This has the advantage that the identifier can be obtained for any type of multimedia object, even when associated metadata may have been lost because of some type of conversion or copying.

The usage information being registered for the multimedia object preferably comprises a number of times the multimedia object is being shared, or an indication of a length of the multimedia object. The predetermined criterion preferably comprises a predetermined number of times the multimedia object has been shared. Other criteria are of course also possible.

In a further embodiment the device is further arranged to sharing of the multimedia object in response to the reporting means failing to transmit the recorded data to the third party. This provides a simple but effective penalty to users who try to prevent transmission of the recorded data in order to prevent being billed for their usage of the object.

In a further embodiment the device further comprises user profile maintenance means for maintaining a user profile, the reporting means being arranged to additionally transmit at least a portion of the user profile to the third party. This has the advantage that it allows the third party to credit the user on his bill for permitting the transmission of user profile data. Such data is valuable to entities like the third party, and the credit on the bill provides an incentive to the user to permit transmission of such data.

The invention further advantageously provides a computer program product being arranged to cause a general purpose computer to operate as the device of the invention.

These and other aspects of the invention will be apparent from and elucidated with reference to the embodiments shown in the drawing, in which:

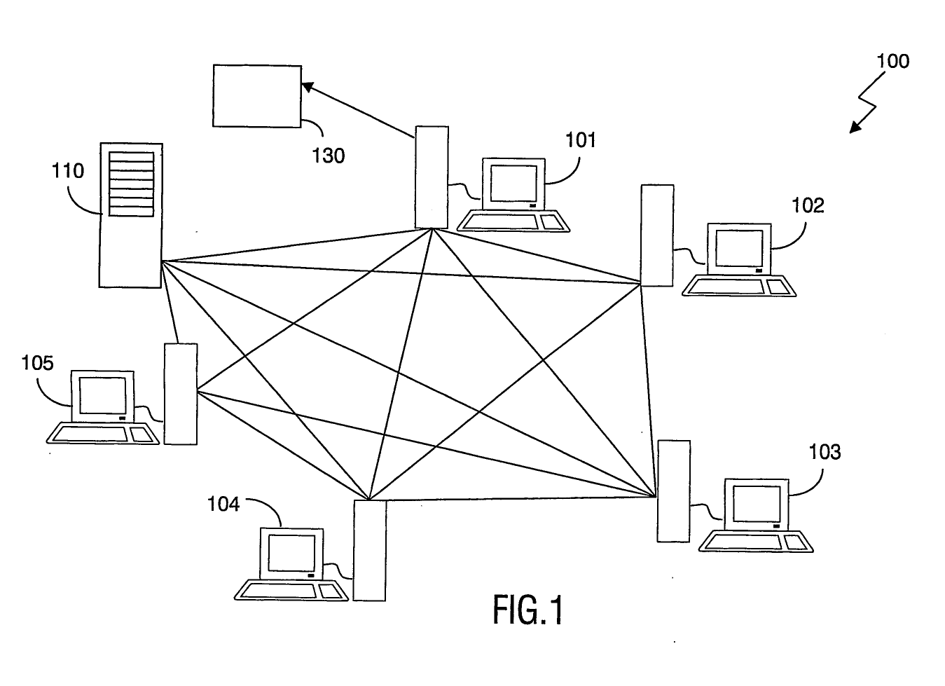

FIG. 1 schematically shows a file sharing network comprising plural clients;

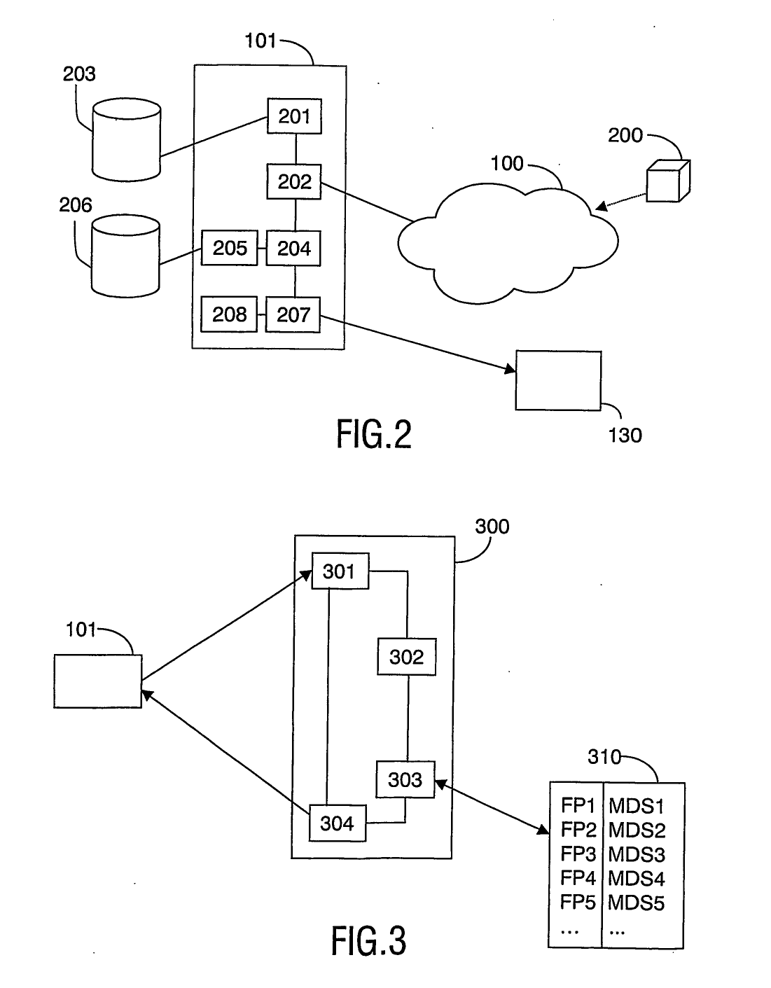

FIG. 2 shows a file sharing client in more detail; and

FIG. 3 schematically shows a server and a fingerprint database in more detail.

Throughout the figures, same reference numerals indicate similar or corresponding features. Some of the features indicated in the drawings are typically implemented in software, and as such represent software entities, such as software modules or objects.

FIG. 1 schematically shows a file sharing network 100 comprising plural file sharing clients 101, 102, 103, 104 and 105. Although shown here as a physical network, with direct connections between the clients 101-105, the network 100 is best regarded as a conceptual or virtual network. That is, it is not necessary that all clients 101-105 are physically or network-wise directly connected to each other all the time. All that is needed is that one client “on the network” can obtain files or objects from another client. Also, even when direct client-to-client connections are used, it is not necessary that all clients are connected to all other clients.

The network 100 may comprise a server 110, which performs a directory service for the clients 101-105. To connect to the file sharing network 100, a client 101 submits a list of the files (or objects) it wants to share to the server 110. The server 110 combines the lists it receives from all the clients connected to the network 100. Other clients 102-105 can then connect to the server 110 and browse the combined list or search for specific objects on the list. They can subsequently contact the client that has the object they are looking for, and obtain (download) it from that client directly. This way, the server 110 does not directly participate in the sharing of files or objects between the clients 101-105. This approach is well known in the worldwide Napster file sharing network.

It is also possible to realize the network 100 without the server 110. In that case, a client 101 connects to the network 100 by connecting to one or more other clients 102-105 that are already on the network 100. A client searches the network by sending a search request to the clients it is connected to. These clients examine their list of objects which they share, and return a result if the requested object is in that list. Furthermore, the request is forwarded to other clients connected to these clients. This way, the request is distributed throughout the entire network 100 until it is received by a client which can fulfill it, or until all clients have received it and none are able to fulfill it.

Such an embodiment is known from e.g. the Gnutella file sharing network. A disadvantage of this embodiment is that the network 100 is not scalable. Gnutella like networks currently for example cannot support 1 million clients. Furthermore the network becomes slow if there are a number of “slow” computers, i.e. computers with limited bandwidth to the network 100, processing power and/or memory.

Alternatively the client 101 can, after connecting to the one or more other clients 102-105, submit its list of files or objects it wants to share to those other clients 102-105. The list is then passed on to all the clients on the network 100. This way, all clients know which clients have which files or objects available, and can contact that client directly.

The known KaZaa file sharing network also operates without a server 110, but to overcome the above-mentioned problem uses two types of clients: a super node and a “normal” client. Super nodes are clients which have sufficient bandwidth, processing power and memory. A normal client connects to the network by connecting to a super node and sends the list of the files to be shared to the super node. A super node has connections to a number of clients and furthermore is also connected to a number of other super nodes.

A super node is at the same time also a normal client. That is, for the user the fact that his computer is a super node is transparent. When a user wants to search for a file, his client sends a request to the super node(s) to which his client is currently connected. The super nodes returns the matching files, that are in the lists send by its clients. Furthermore the super node forwards the request, if necessary, to all the super nodes to which it is connected in a fashion similar to the one described above in the Gnutella embodiment. However, since the connections between super nodes have a large bandwidth this approach is much faster than the Gnutella networks. Furthermore it can be scaled up to millions of clients.

Such file sharing networks, typically referred to as peer-to-peer or P2P file sharing networks, have an enormous popularity. Well known examples of these networks are: Napster, Musiccity, Gnutella, Kazaa, Imesh and Bearshare. Once users have installed the appropriate client software on their personal computers, they can share their files and they are able to download files shared by other users. The clients 101-105 may be connected to a network such as the Internet, which facilitates the establishment of the file sharing network 100. A client could e.g. use a direct TCP/IP connection to another client to obtain a file or object.

On the most popular networks, usually over 500,000 people are connected simultaneously. At the time of writing, people are mostly sharing music files (often in the MP3 format), but the sharing of movies is gaining popularity. The term “multimedia object” will be used to denote files containing music, songs, movies, TV programs, pictures and other types of binary data, but also textual data can be shared in this fashion. It is to be noted that a multimedia object may be made up of several different files.

In accordance with the present invention, the file sharing clients 101-105 obtain identifiers for multimedia objects they share and register usage information for these multimedia objects. The usage information is then supplied to a third party 130. The third party 130 subsequently bills the user of the clients in accordance with the registered usage information. The third party 130 could for example be a copyright clearinghouse such as the RIAA or the Dutch BUMA/Stemra. The third party 130 could be a party to the file sharing network 100, although this is not necessary. The file sharing clients 101-105 could simply employ a direct Internet connection, e.g. using the World-Wide Web, to the third party 130, e-mail the usage information to an e-mail address for the third party 130 or use some other channel to transmit the usage information to the third party 130.

FIG. 2 shows the file sharing client 101 in more detail. The file sharing client 101 is preferably realized as a personal computer on which file sharing software 201 is running, as is well-known in the art. The file sharing software 201 typically makes use of a networking module 202, such as the TCP/IP stack available in modern operating systems. The file sharing software 201 is arranged to download a multimedia object 200 over the file sharing network 100, e.g. from one of the other file sharing clients 102-105, as is known in the art.

A storage medium 203 contains one or more multimedia objects which are shared by the file sharing software 201. Such a storage medium 203 would typically be a directory on a hard disk. In some cases, the storage medium 203 may contain a separate portion in which downloaded multimedia objects are stored. This portion, typically also a directory, is not necessarily the same as the directory in which multimedia objects to be shared are stored.

The file sharing client 101 also comprises a fingerprinting module 204, which can compute a fingerprint from a multimedia object. The fingerprinting module 204 is preferably realized as one or more hardware or software modules, for example as a plug-in module in the file sharing software 201 running on the client 101.

A fingerprint of a multimedia object is a representation of the most relevant perceptual features of the object in question. Such fingerprints are sometimes also known as “(robust) hashes”. The fingerprints of a large number of multimedia objects along with their associated respective metadata, such as the title, artist, genre and so on, are stored in a database. The metadata of a multimedia object is retrieved by computing its fingerprint and performing a lookup or query in the database using the computed fingerprint as a lookup key or query parameter. The lookup then returns the metadata associated with the fingerprint.

An example of a method of computing such a fingerprint is described in European patent application number 01200505.4 (attorney docket PHNL010110), as well as in Jaap Haitsma, Ton Kalker and Job Oostveen, “Robust Audio Hashing For Content Identification”, International Workshop on Content-Based Multimedia Indexing, Brescia, September 2001. Of course any method for computing a fingerprint can be used.

European patent application 01200505.4 describes a method that generates robust fingerprints for multimedia objects such as, for example, audio clips. The audio clip is divided in successive (preferably overlapping) time intervals. For each time interval, the frequency spectrum is divided in bands. A robust property of each band (e.g. energy) is computed and represented by a respective fingerprint bit.

A multimedia object is thus represented by a fingerprint comprising a concatenation of binary values, one for each time interval. The fingerprint does not need to be computed over the whole multimedia object, but can be computed when a portion of a certain length, typically about three seconds, has been received. There can thus be plural fingerprints for one multimedia object, depending on which portion is used to compute the fingerprint over. For reasons of clarity, the term “the fingerprint” will be used even in cases when multiple fingerprints for one multimedia object can exist.

The fingerprint for the multimedia object 200 can be considered to be an identifier for the multimedia object 200 if the method used to calculate the fingerprint is robust enough. When reporting usage information the fingerprint can be supplied to the third party 130 as well, allowing the third party 130 to properly identify the multimedia object 200. However, since there is always a slight chance that a particular fingerprint is unreliable, it is recommended that after computing a fingerprint, a database lookup is performed to obtain metadata comprising a proper identifier. Such a lookup typically takes only a few seconds. If the lookup fails, the fingerprinting module 204 can easily compute a new fingerprint for the multimedia object 200 (e.g. from another part of the object) and to perform a database lookup using the new fingerprint.

Usually, the database lookup is handled by a central server. This way, the client 101 does not need to maintain the rather large database necessary to identify multimedia objects by their fingerprints. The workings of such a central server are explained below with reference to FIG. 3.

A fingerprint for a multimedia object can be computed while that object is being downloaded or uploaded (shared). Some methods of computing a fingerprint operate on small portions of a multimedia object at a time. For example, the above-mentioned European patent application computes a “sub-fingerprint” for every three seconds of audio data in the multimedia object, and constructs the actual fingerprint from all the sub-fingerprints. Computing the sub-fingerprints can then start once three seconds worth of data has been received.

An accounting module 205 receives the fingerprint, or the metadata obtained through a database lookup based on the fingerprint, from the fingerprinting module 204. The module 205 then registers usage information for the multimedia object in question in storage medium 206. The storage medium 206 could for example be a small hard disk in the client 101. To avoid tampering with the registered usage information, a secure storage medium can be used.

Registering the usage information can take place whenever the file sharing software 201 actually transmits a multimedia object to another client 102-105, or when the object is placed in the storage medium 203.

The registered usage information serves as the basis for afterwards billing. This means that the accounting module 205 has to be programmed with advance knowledge of the billing model that will be used. For example, if billing is done on a pay-per-copy basis, the accounting module 205 only needs to keep track of the number of times a particular multimedia object has been played. If the duration of the object matters, this duration also should be recorded. The accounting module 205 monitors the operations performed by the playback module 101 to obtain the necessary usage information.

When the recorded data meets a predetermined criterion, a reporting module 207 transmits the recorded data to the third party 130 to allow afterwards billing for sharing of the multimedia object 200 in accordance with the registered usage information for the multimedia object 200. An important issue is when the client 101 should submit the information, i.e. what predetermined criterion should be used to determine whether the registered usage information should be transmitted to the third party. Various possibilities exist. Probably the most straightforward one is a fixed period of time, such as a week or a month, after the last time the usage information was transmitted.

Alternatively, the predetermined criterion could comprise a predetermined number of identifiers being recorded. This way, users who share a lot of multimedia objects are billed more often than people who only occasionally listen to a song. Further, it is now no longer necessary to send out bills for trivial amounts of money, which would be the case with periodic billing for people who only occasionally use multimedia objects.

Instead of only keeping track of the number of multimedia objects, additionally also the length (in seconds) of the multimedia objects can be recorded. For example, the module 205 could record that a particular object only lasts for 10 seconds, and another song is 4 minutes 30 seconds. In this case, the predetermined criterion could be chosen on the basis of the recorded amounts of time, for example as a predetermined total amount of time being recorded. This way, users can cheaply share short fragments, but those who distribute complete songs, or complete albums will be billed often.

A budget-based approach is also possible. This requires that the accounting module 205 has at least some knowledge of the costs associated with particular types of sharing. For example, the user of the client 101 may be provided with a budget of 20 Euros. Upon sharing of the multimedia object 200, the accounting module 205 determines the costs associated with such playback and subtracts it from the budget. The predetermined criterion then represents the case that the budget has reached zero, or is within a certain distance from zero. A similar effect can be achieved by choosing as the predetermined criterion a maximum amount of money and instead of subtracting from the budget, adding up the costs until the predetermined maximum has been reached.

It maybe desirable to give the user of the device a choice between the various possible predetermined criteria. Some users prefer periodic billing, and others would rather have usage-based bills. The actual values used in the predetermined criteria could also be user defined.

Various enhancements are possible to improve the workings of the client 101. For example, the client 101 may further comprise a user profile maintenance module 208 which maintains a user profile for the user. Such a profile comprises information regarding the user's browsing habits, lifestyle, interests, favorite search keywords and other information that can be gathered by observing the user's browsing behavior. This allows, among other things, the client 101 to recommend multimedia objects that may be of interest to the user, or to filter out multimedia objects that are less likely to be of interest.

It is also possible to use such user profile information for targeted marketing or advertising. See e.g. international patent application PCT/IB02/00073 (attorney docket PHNL020072) by the same applicant as the present application. It is thus desirable from a marketing point of view to gain access to user profile information maintained by the module 208. To provide an incentive to the user to supply his user profile information, he could be credited on the bill which he needs to pay for the sharing of the multimedia objects. The reporting module 207 is now arranged to additionally transmit at least a portion of the user profile to the third party 130.

Additionally, some penalties can be provided in case the reporting module 207 fails to transmit the recorded data to the third party 130. If this happens more than once or twice, one could reasonably assume that the user is trying to prevent the transmission of the recorded data to prevent being billed. In response, the reporting module 207 could cause the file sharing module 201 to inhibit sharing of the multimedia object. This inhibition can be lifted once the reporting module 207 is able to transmit the recorded data again.

The registered usage information should be protected against unauthorized modifications. Also, the fingerprinting module 204 should be protected against tampering, so that a user cannot disable the fingerprinting or the accounting afterwards. There are various ways to achieve this. In one embodiment, some or all parts of the client 101 are implemented as hardware modules, making them difficult to modify. In another embodiment, the modules 204, 205, 207 and the storage medium 206 are provided on a smart card which prevents tampering. The file sharing software 201 then should refuse to operate if the smart card is not inserted.

Another embodiment uses trusted computing technology, for example as developed by the Trusted Computing Platform Alliance (http://www.trustedpc.org/). This technology is based on secure hardware modules or chips installed in a general purpose computer (PC). The chips, known as trusted platform modules (or TPMs), generally include a 16-bit microprocessor, a random number generator, an encryption accelerator, hashing capabilities and nonvolatile memory. TPMs can generate and securely store on-chip digital certificates and private keys, provide hardware support for multiple authentication schemes and handle encryption and decryption of files on demand.

FIG. 3 schematically shows a server 300 and a fingerprint database 310 in more detail. The server 300 here comprises an input module 301, an optional fingerprinting module 302, a Database Management System (DBMS) backend module 303, and a response module 304.

The input module 301 receives a fingerprint from the client 101 and supplies the fingerprint to the DBMS backend module 303. In an alternative embodiment, the input module 301 receives a plurality of audio clips from the client 101 instead of a number of fingerprints. These audio clips are then fed to the fingerprinting module 302. The fingerprinting module 302 computes a fingerprint from the received audio clip. As mentioned above, one method for computing a robust fingerprint is described in European patent application 01200505.4 (attorney docket PHNL01110), although of course any method for computing a robust fingerprint can be used. The fingerprinting module 302 then supplies the computed fingerprint to the DBMS backend module 303.

The DBMS backend module 303 performs a query on the database 310 to retrieve a set of metadata associated with the received fingerprints from the database 310. As shown in FIG. 3, the database 310 comprises fingerprints FP1, FP2, FP3, FP4 and FP5 and respective associated sets of metadata MDS1, MDS2, MDS3, MDS4 and MDS5. The above-mentioned European patent application 01200505.4 (attorney docket PHNL010110) describes various matching strategies for matching fingerprints computed for an audio clip with fingerprints stored in a database.

European patent application 01202720.7 (attorney docket PHNL010510) describes an efficient method of matching a fingerprint representing an unknown information signal with a plurality of fingerprints of identified information signals stored in a database to identify the unknown signal. This method uses reliability information of the extracted fingerprint bits. The fingerprint bits are determined by computing features of an information signal and thresholding said features to obtain the fingerprint bits. If a feature has a value very close to the threshold, a small change in the signal may lead to a fingerprint bit with opposite value. The absolute value of the difference between feature value and threshold is used to mark each fingerprint bit as reliable or unreliable. The reliabilities are subsequently used to improve the actual matching procedure.

The database 310 can be organized in various ways to optimize query time and/or data organization. The output of the fingerprinting module 204 (or fingerprinting module 302) should be taken into account when designing the tables in the database 310. In the embodiment shown in FIG. 3, the database 310 comprises a single table with entries (records) comprising respective fingerprints and sets of metadata.

Another way to realize the database 310 is to set up several tables. A first table comprises a plurality of unique identifiers (primary keys) each associated with respective sets of metadata. Such tables can be obtained from various music identification sources. The combination of artist, title and year of release could be combined to form a unique identifier, although this is not guaranteed to be unique, so preferably a really globally unique value is used.

A second table is then set up with entries comprising for each multimedia object the fingerprints and the unique identifiers from the first table. This way, multiple fingerprints can be associated with one set of metadata without having to duplicate metadata. If multiple fingerprints are possible for one multimedia object, all these fingerprints are stored in the second table, all associated with the one unique identifier for that multimedia object.

The DBMS backend module 303 then matches the received fingerprints against the fingerprints in the second table, obtains an identifier and matches the identifier against the first table to obtain the metadata. If the database 310 is an SQL database, the two tables could be joined on the identifier. The DBMS backend module 303 feeds the results of the query to the response module 304, which transmits the metadata found back to the client 101.

It should be noted that the above-mentioned embodiments illustrate rather than limit the invention, and that those skilled in the art will be able to design many alternative embodiments without departing from the scope of the appended claims.

For example, as an alternative to fingerprinting, identifiers embedded in multimedia objects using digital watermarks could be used. The client 101 then comprises a watermark detector arranged to detect a watermark in the multimedia object 200 and to extract the identifier from the watermark. Watermarking, the process of inserting extra information in a signal such as an audio or video signal, is an important and well-known technique to mark or protect those signals.

Watermarking an image is essentially a process of altering the pixel values of an image in a manner that ensures that a viewer of the image does not notice any perceptual change between the original and the watermarked image. Altering a large number of pixel values in an arbitrary manner will result in noticeable artifacts. Every pixel value of an image can be altered only to a certain limit without making perceptible differences to the image quality. For audio, the audio signal is modified in a way that a person listening to the resulting audio signal does not notice any perceptual change between the original and the watermarked signal. Technologies for watermarking audio and/or video, and for reliably detecting such watermarks are well known in the art and will not be elaborated upon further.

The alterations in the audio or video signal are typically used to hold some extra information. A watermark detector can extract this extra information by looking at the specific alterations. For instance, a simple watermarking technique manipulates the least significant bit (LSB) of every data word representing the signal. If a bit of the extra information represents a zero, the corresponding LSB is also set to zero. Similarly, if a bit of the extra information represents a one, the corresponding LSB is also set to one.

In this embodiment the extra information represents the identifier for the multimedia object 200. The identifier could be simply an (alpha)numerical string which uniquely identifies the multimedia object 200. For instance, if the multimedia object 200 comprises an electronic book, its ISBN could be embedded using a watermark. The ISBN uniquely identifies the book.

Of course more extensive identifiers could also be used. The only limitation is how much information can be embedded using the chosen watermark technology. If technology (and the size of the multimedia object 200) permits it, one could for instance embed the full title, author, publisher and so on in the multimedia object 200.

The database 310 and some or all of the modules 301-304 could be installed in the device 101, if enough storage space and processing capacity is available. This way, no network connection is necessary. Alternatively, the database 310 could be maintained in a distributed fashion, as is described in European patent application 01204599.3 (attorney docket PHNL010874) by the same applicant as the present application.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of regulating sharing of a multimedia object by a device, comprising registering usage information for the multimedia object upon sharing of the multimedia object, and after the registering, billing a user of the device for a certain amount in accordance with the registered usage information for the multimedia object.

2. The method of claim 1, further comprising recording user profile information for the user, and crediting the bill with a sum upon receipt of the recorded user profile information together with the registered usage information.

3. A device arranged for sharing of a multimedia object, comprising file sharing means for sharing the multimedia object with other devices, identifying means for obtaining an identifier for the multimedia object being shared, accounting means for registering usage information for the identified multimedia object, reporting means for, when the recorded data meets a predetermined criterion, transmitting the registered usage information to a third party to allow afterwards billing for sharing of the multimedia object in accordance with the registered usage information for the multimedia object.

4. The device of claim 3, in which the identifying means are arranged to obtain the identifier from metadata associated with the multimedia object.

5. The device of claim 4, in which the identifying means comprise a watermark detector arranged to detect a watermark in the multimedia object and to extract the identifier from the metadata encoded using the watermark.

6. The device of claim 3, in which the identifying means comprise a fingerprint calculator arranged to obtain the identifier by computing a fingerprint for at least a portion of the multimedia object.

7. The device of claim 3, in which the usage information being registered for the multimedia object comprises a number of times the multimedia object is being shared.

8. The device of claim 3, in which the usage information being registered for the multimedia object comprises an indication of a length of the multimedia object.

9. The device of claim 3, in which the predetermined criterion comprises a predetermined number of times the multimedia object has been shared.

10. The device of claim 3, being arranged to inhibit sharing of the multimedia object in response to the reporting means failing to transmit the recorded data to the third party.

11. The device of claim 3, further comprising user profile maintenance means for maintaining a user profile, the reporting means being arranged to additionally transmit at least a portion of the user profile to the third party.

12. A computer program product being arranged to cause a general purpose computer to operate as the device of claim 3.
